(19) United States
(12) Patent Application Publication
(10) Pub. No.: US 2011/0173420 A1
(43) Pub. Date: Jul. 14, 2011

(54) PROCESSOR RESUME UNIT

(75) Inventors: Dong Chen, Yorktown Heights, NY (US); Mark Giampapa, Yorktown Heights, NY (US); Philip Heidelberger, Yorktown Heights, NY (US); Martin Ohmacht, Yorktown Heights, NY (US); David L. Satterfield, Tewksbury, MA (US); Burkhard Steinmacher-Burow, Boeblingen (DE); Krishnan Sugavanam, Yorktown Heights, NY (US)

(73) Assignee: INTERNATIONAL BUSINESS MACHINES CORPORATION, Armonk, NY (US)

(21) Appl. No.: 12/684,852

(22) Filed: Jan. 8, 2010

(51) Int. Cl. G06F 9/30

(52) U.S. Cl. 712/220; 712/E09.016

(57) ABSTRACT

A system for enhancing performance of a computer includes a computer system having a data storage device. The computer system includes a program stored in the data storage device and steps of the program are executed by a processor. An external unit is external to the processor for monitoring specified computer resources. The external unit is configured to detect a specified condition using the processor. The processor including one or more threads. The thread resumes an active state from a pause state using the external unit when the specified condition is detected by the external unit.

### CROSS-REFERENCE TO RELATED APPLICATIONS

The present invention is related to the following commonly-owned, co-pending United States patent applications filed on even date herewith, the entire contents and disclosure of each of which is expressly incorporated by reference herein as if fully set forth herein. U.S. patent application Serial No. (YOR920090171US1 (24255)), for “USING DMA FOR COPYING PERFORMANCE COUNTER DATA TO MEMORY”; U.S. patent application Serial No. (YOR920090169US1 (24259)) for “HARDWARE SUPPORT FOR COLLECTING PERFORMANCE COUNTERS DIRECTLY TO MEMORY”; U.S. patent application Serial No. (YOR920090168US1 (24260)) for “HARDWARE ENABLED PERFORMANCE COUNTERS WITH SUPPORT FOR OPERATING SYSTEM CONTEXT SWITCHING”; U.S. patent application Serial No. (YOR920090473US 1 (24595)), for “HARDWARE SUPPORT FOR SOFTWARE CONTROLLED FAST RECONFIGURATION OF PERFORMANCE COUNTERS”; U.S. patent application Serial No. (YOR920090474US1 (24596)), for “HARDWARE SUPPORT FOR SOFTWARE CONTROLLED FAST MULTIPLEXING OF PERFORMANCE COUNTERS”; U.S. patent application Serial No. (YOR920090533US1 (24682)), for “CONDITIONAL LOAD AND STORE IN A SHARED CACHE”; U.S. patent application Serial No. (YOR920090532US 1 (24683)), for “DISTRIBUTED PERFORMANCE COUNTERS”; U.S. patent application Serial No. (YOR920090529US 1 (24685)), for “LOCAL ROLLBACK FOR FAULT-TOLERANCE IN PARALLEL COMPUTING SYSTEMS”; U.S. patent application Serial No. (YOR920090530US 1 (24686)), for “PROCESSOR WAKE ON PIN”; U.S. patent application Serial No. (YOR920090526US1 (24687)), for “PRECAST THERMAL INTERFACE ADHESIVE FOR EASY AND REPEATED, SEPARATION AND REMATING”; U.S. patent application Serial No. (YOR920090527US1 (24688), for “ZONE ROUTING IN A TORUS NETWORK”; U.S. patent application Serial No. (YOR920090535US1 (24690)), for “TLB EXCLUSION RANGE”; U.S. patent application Serial No. (YOR920090536US1 (24691)), for “DISTRIBUTED TRACE USING CENTRAL PERFORMANCE COUNTER MEMORY”; U.S. patent application Serial No, (YOR920090538US1 (24692)), for “PARTIAL CACHE LINE SPECULATION SUPPORT”; U.S. patent application Serial No. (YOR920090539US1 (24693)), for “ORDERING OF GUARDED AND UNGUARDED STORES FOR NO-SYNC I/O”; U.S. patent application Serial No. (YOR920090540US 1 (24694)), for “DISTRIBUTED PARALLEL MESSAGING FOR MULTIPROCESSOR SYSTEMS”; U.S. patent application Serial No. (YOR920090541US1 (24695)), for “SUPPORT FOR NON-LOCKING PARALLEL RECEPTION OF PACKETS BELONGING TO THE SAME MESSAGE”; U.S. patent application Serial No. (YOR920090560US1 (24714)), for “OPCODE COUNTING FOR PERFORMANCE MEASUREMENT”; U.S. patent application Serial No. (YOR920090578US1 (24724)), for “MULTI-INPUT AND BINARY REPRODUCIBLE, HIGH BANDWIDTH FLOATING POINT ADDER IN A COLLECTIVE NETWORK”; U.S. patent application Serial No. (YOR920090579US1 (24731)), for “A MULTI-PETASCALE HIGHLY EFFICIENT PARALLEL SUPERCOMPUTER”; U.S. patent application Serial No, (YOR920090581US1 (24732)), for “CACHE DIRECTORY LOOK-UP REUSE”; U.S. patent application Serial No. (YOR920090582US1 (24733)), for “MEMORY SPECULATION IN A MULTI LEVEL CACHE SYSTEM”; U.S. patent application Serial No. (YOR920090583US 1 (24738)), for “METHOD AND APPARATUS FOR CONTROLLING MEMORY SPECULATION BY LOWER LEVEL CACHE”; U.S. patent application Serial No. (YOR920090584US 1 (24739)), for “MINIMAL FIRST LEVEL CACHE SUPPORT FOR MEMORY SPECULATION MANAGED BY LOWER LEVEL CACHE”; U.S. patent application Serial No. (YOR920090585US1 (24740)), for “PHYSICAL ADDRESS ALIASING TO SUPPORT MULTI-VERSIONING IN A SPECULATION-UNAWARE CACHE”; U.S. patent application Serial No. (YOR920090587US1 (24746)), for “LIST BASED PREFETCH”; U.S. patent application Serial No. (YOR920090590US1 (24747)), for “PROGRAMMABLE STREAM PREFETCH WITH RESOURCE OPTIMIZATION”; U.S. patent application Serial No. (YOR920090595US1 (24757)), for “FLASH MEMORY FOR CHECKPOINT STORAGE”; U.S. patent application Serial No. (YOR920090596US1 (24759)), for “NETWORK SUPPORT FOR SYSTEM INITIATED CHECKPOINTS”; U.S. patent application Serial No. (YOR920090597US1 (24760)), for “TWO DIFFERENT PREFETCH COMPLEMENTARY ENGINES OPERATING SIMULTANEOUSLY”; U.S. patent application Serial No. (YOR920090598US1 (24761)), for “DEADLOCK-FREE CLASS ROUTES FOR COLLECTIVE COMMUNICATIONS EMBEDDED IN A MULTI-DIMENSIONAL TORUS NETWORK”; U.S. patent application Serial No. (YOR920090631US1 (24799)), for “IMPROVING RELIABILITY AND PERFORMANCE OF A SYSTEM-ON-A-CHIP BY PREDICTIVE WEAR-OUT BASED ACTIVATION OF FUNCTIONAL COMPONENTS”; U.S. patent application Serial No. (YOR920090632US1 (24800)), for “A SYSTEM AND METHOD FOR IMPROVING THE EFFICIENCY OF STATIC CORE TURN OFF IN SYSTEM ON CHIP (SoC) WITH VARIATION”; U.S. patent application Serial No. (YOR920090633US1 (24801)), for “IMPLEMENTING ASYNCHRONOUS COLLECTIVE OPERATIONS IN A MULTI-NODE PROCESSING SYSTEM”; U.S. patent application Serial No. (YOR920090586US1 (24861)), for “MULTIFUNCTIONING CACHE”; U.S. patent application Serial No. (YOR920090645US1 (24873)) for “I/O ROUTING IN A MULTIDIMENSIONAL TORUS NETWORK”; U.S. patent application Serial No. (YOR920090646US1 (24874)) for ARBITRATION IN CROSSBAR FOR LOW LATENCY; U.S. patent application Serial No. (YOR920090647US1 (24875)) for EAGER PROTOCOL ON A CACHE PIPELINE DATAFLOW; U.S. patent application Serial No. (YOR920090648US1 (24876)) for EMBEDDED GLOBAL BARRIER AND COLLECTIVE IN A TORUS NETWORK; U.S. patent application Serial No. (YOR920090649US1 (24877)) for GLOBAL SYNCHRONIZATION OF PARALLEL PROCESSORS USING CLOCK PULSE WIDTH MODULATION; U.S. patent application Serial No. (YOR920090650US1 (24878)) for IMPLEMENTATION OF MSYNC; U.S. patent application Serial No. (YOR920090651US1 (24879)) for NON-STANDARD FLAVORS OF MSYNC; U.S. patent application Serial No. (YOR920090652US1 (24881)) for HEAP/STACK GUARD PAGES USING A WAKEUP UNIT; U.S. patent application Serial No. (YOR920100002US1 (24882)) for MECHANISM OF SUPPORTING SUB-COMMUNICATOR COLLECTIVES WITH 0(64) COUNTERS AS OPPOSED TO ONE COUNTER FOR EACH SUB-COMMUNICATOR; and U.S. patent application Serial No. (YOR920100001US1 (24883)) for REPRODUCIBILITY IN BGQ.

### STATEMENT REGARDING FEDERALLY SPONSORED RESEARCH OF DEVELOPMENT

This invention was made with Government support under Contract No.: B554331 awarded by the Department of Energy. The Government has certain rights in this invention.

### FIELD OF THE INVENTION

The present invention generally relates to a method and system for enhancing performance in a computer system, and more particularly, a method and system for enhancing efficiency and performance of processing in a computer system and in a processor with multiple processing threads, for use in a massively parallel supercomputer.

### BACKGROUND OF THE INVENTION

PM Modern processors typically include multiple hardware threads related to threads of an executed software program. Each hardware thread is competing for common resources internally in the processor. In many cases, a thread may be waiting for an action to occur external to the processor. For example, a thread may be polling an address residing in cache memory, while waiting for another thread to update it. The polling action takes resources away from other competing threads on the processor. For example, multiple threads existing within the same process and sharing resources, such as, memory.

Current processors typically include several threads, each sharing processor resources with each other. A thread blocked in a polling loop is taking cycles from the other threads in the processor core. The performance cost is especially high if the polled variable is L1-cached (primary cache), since the frequency of the loop is highest. Similarly, the performance cost is high if, for example, a large number of L1-cached addresses are polled, and thus take L1 space from other threads.

Multiple hardware threads in processors may also apply to high performance computing (HPC) or supercomputer systems and architectures such as IBM® BLUE GENE® parallel computer system, and to a novel massively parallel supercomputer scalable, for example, to 100 petaflops. Massively parallel computing structures (also referred to as “supercomputers”) interconnect large numbers of compute nodes, generally, in the form of very regular structures, such as mesh, torus, and tree configurations. The conventional approach for the most cost/effective scalable computers has been to use standard processors configured in uni-processors or symmetric multiprocessor (SMP) configurations, wherein the SMPs are interconnected with a network to support message passing communications. Currently, these supercomputing machines exhibit computing performance achieving 1-3 petaflops.

There is therefore a need to increase application performance by reducing the performance loss of the application, for example, reducing the increased cost of software in a loop, for example, such as when software may be blocked in a spin loop or similar blocking polling loop. Further, there is a need to reduce performance loss, i.e., consuming processor resources, caused by polling and the like to increase overall performance. It would also be desirable to provide a system and method for polling external conditions while minimizing consuming processor resources, and thus increasing overall performance.

### SUMMARY OF THE INVENTION

In an aspect of the invention, a method for enhancing performance of a computer includes: providing a computer system including a data storage device, the computer system including a program stored in the data storage device and steps of the program being executed by a processor; processing instructions from the program using the processor, the processor having a thread; monitoring specified computer resources using an external unit being external to the processor; configuring the external unit to detect a specified condition, the external unit being configured using the processor; initiating a pause state for the thread after the step of configuring the external unit, the thread including an active state; detecting the specified condition using the external unit; and resuming the active state of the thread using the external unit when the specified condition is detected by the external unit.

In a related aspect, the resources are memory resources. In another related aspect, the method may further comprise a plurality of conditions, including: writing to a memory location; receiving an interrupt command, receiving data from an I/O device, and expiration of a timer. Also, the thread may initiate the pause state itself. The method of claim 1 may further comprise: configuring the external unit to detect the specified condition continuously over a period of time; and polling the specified condition such that the thread and the external unit provide a polling loop of the specified condition. Further, the method may further comprise defining an exit condition of the polling loop such that the external unit stops detecting the specified condition when the exit condition is met. Also, the exit condition may be a period of time.

In an aspect of the invention, a system for enhancing performance of a computer includes a computer system including a data storage device. The computer system includes a program stored in the data storage device and steps of the program being executed by a processor. The processor processes instructions from the program. An external unit is external to the processor for monitoring specified computer resources, and the external unit is configured to detect a specified condition using the processor. The thread resumes an active state from a pause state using the external unit when the specified condition is detected by the external unit.

In a related aspect, the system includes a polling loop for polling the specified condition using the thread and the external unit to poll for the specified condition over a period of time. The system may further include an exit condition of the polling loop such that the external unit stops detecting the specified condition when the exit condition is met.

In another aspect of the invention, a computer program product comprises a computer readable medium having recorded thereon a computer program, a computer system includes a processor for executing the steps of the computer program for enhancing performance of a computer, the program steps comprising: processing instructions from the program using the processor; monitoring specified computer resources using an external unit being external to the processor; configuring the external unit to detect a specified condition; initiating a pause state for a thread of the processor after the step of configuring the external unit, detecting the specified condition using the external unit; and resuming an active state of the thread using the external unit when the specified condition is detected by the external unit.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram of a system and method for monitoring and managing resources on a computer according to an embodiment of the invention;

FIG. 2 is a flow chart illustrating a method according to the embodiment of the invention shown in FIG. 1 for monitoring and managing resources on a computer;

FIG. 3 is a schematic block diagram of a system for enhancing performance of computer resources according to an embodiment of the invention;

FIG. 4 is a schematic block diagram of a system for enhancing performance of computer resources according to an embodiment of the invention; and

FIG. 5 is a schematic block diagram of a system for enhancing performance of a computer according to an embodiment of the invention.

### DETAILED DESCRIPTION OF THE INVENTION

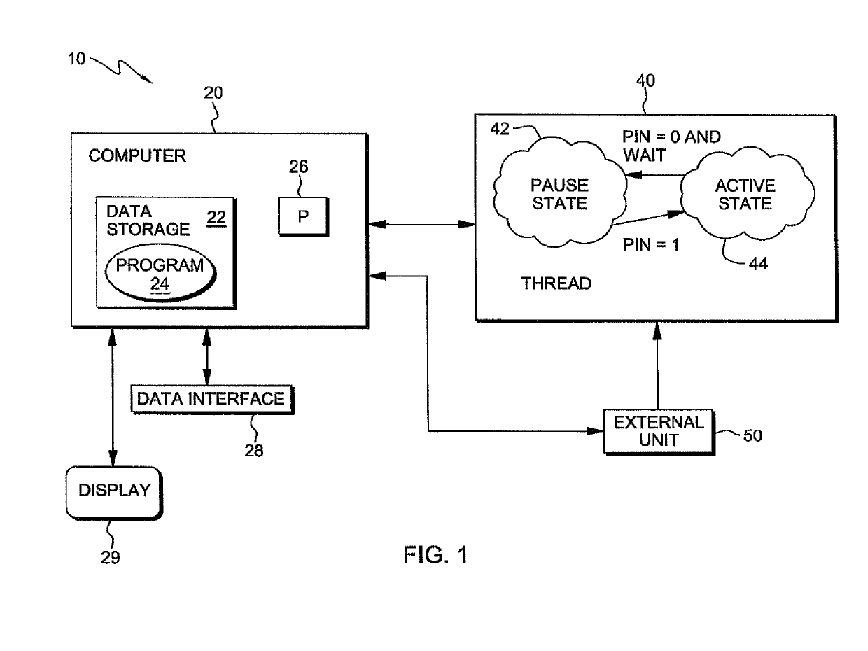

Referring to FIG. 1, a system 10 according to one embodiment of the invention for monitoring computing resources on a computer includes a computer 20. The computer 20 includes a data storage device 22 and a software program 24 stored in the data storage device 22, for example, on a hard drive, or flash memory. The processor 26 executes the program instructions from the program 24. The computer 20 is also connected to a data interface 28 for entering data and a display 29 for displaying information to a user. A monitoring module 30 is part of the program 24 and monitors specified computer resources using an external unit 50 (interchangeably referred to as the wakeup unit herein) which is external to the processor. The external unit 50 is configured to detect a specified condition, or in an alternative embodiment, a plurality of specified conditions. The external unit 50 is configured by the program 24 using a thread 40 communicating with the external unit 50 and the processor 26. After configuring the external unit 50, the program 24 initiates a pause state for the thread 40. The external unit 50 waits to detect the specified condition. When the specified condition is detected by the external unit 50, the thread 40 is awakened from the pause state by the external unit.

Thus, the present invention increases application performance by reducing the performance cost of software blocked in a spin loop or similar blocking polling loop. In one embodiment of the invention, a processor core has four threads, but performs at most one integer instruction and one floating point instruction per processor cycle. Thus, a thread blocked in a polling loop is taking cycles from the other three threads in the core. The performance cost is especially high if the polled variable is L1-cached, since the frequency of the loop is highest. Similarly, the performance cost is high if a large number of L1-cached addresses are polled and thus take L1 space from other threads.

In the present invention, the WakeUp-assisted loop has a lower performance cost, compared to the software polling loop. In one embodiment of the invention, the external unit is embodied as a wakeup unit, the thread 40 writes the base and enable mask of the address range to the WakeUp address compare (WAC) registers of the WakeUp unit. The thread then puts itself into a paused state. The WakeUp unit wakes up the thread when any of the addresses are written to. The awoken thread then reads the data value(s) of the address(es). If the exit condition is reached, the thread exits the polling loop. Otherwise a software program again configures the WakeUp unit and the thread again goes into a paused state, continuing the process as described above. In addition to address comparisons, the WakeUp unit can wake a thread on signals provided by the message unit (MU) or by the core-to-core (c2c) signals provided by the BIC.

Polling may be accomplished by the external unit or WakeUp unit when, for example, messaging software places one or more communication threads on a memory device. The communication thread learns of new work, i.e., a detected condition or event, by polling an address, which is accomplished by the WakeUp unit. If the memory device is only running the communication thread, then the WakeUp unit will wake the paused communication thread when the condition is detected. If the memory device is running an application thread, then the WakeUp unit, via a bus interface card (BIC), will interrupt the thread and the interrupt handler will start the communication thread. A thread can be woken by any specified event or a specified time interval.

The system of the present invention thereby, reduces the performance cost of a polling loop on a thread within a core having multiple threads. In addition, the system of the present invention includes the advantage of waking a thread only when a detected event or signal has occurred and thus, there is not a falsely woken up thread if a signal(s) has not occurred. For example, a thread may be woken up if a specified address or addresses have been written to by any of a number of threads on the chip. Thus, the exit condition of a polling loop will not be missed.

In another embodiment of the invention, an exit condition of a polling loop is checked by the awakened thread as actually occurring. Such reasons for a thread being woken even if a specified address(es) has not been written to, include, for example, false sharing of the same L1 cache line, or an L2 castout due to resource pressure.

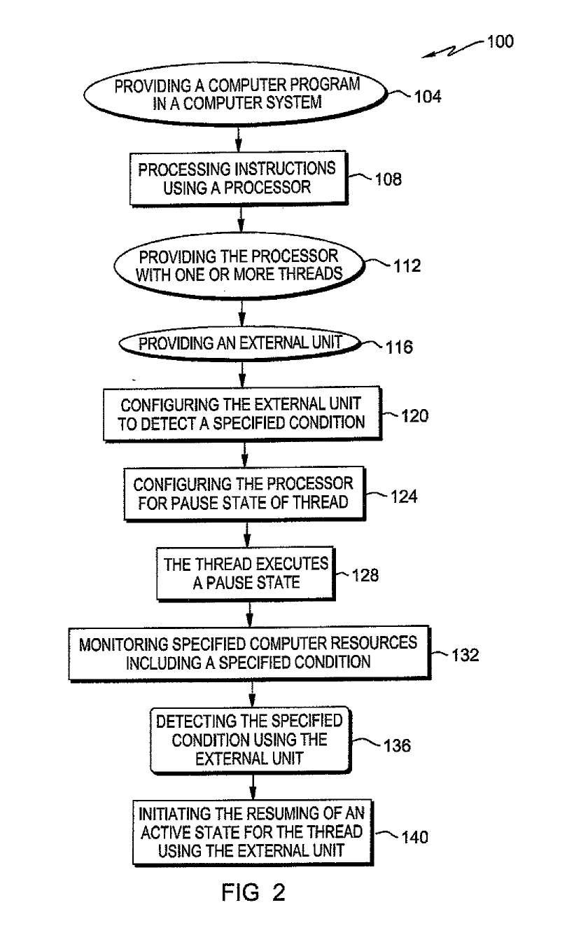

Referring to FIG. 2, a method 100 for monitoring and managing resources on a computer system according to an embodiment of the invention includes a computer system 20. The method 100 incorporates the embodiment of the invention shown in FIG. 1 of the system 10. As in the system 10, the computer system 20 includes a computer program 24 stored in the computer system 20 in step 104. A processor 26 in the computer system 20 processes instructions from the program 24 in step 108. The processor is provided with one or more threads in step 112. An external unit is provided in step 116 for monitoring specified computer resources and is external to the processor. The external unit is configured to detect a specified condition in step 120 using the processor. The processor is configured for the pause state of thread in step 124. The thread is normally in an active state and the thread executes a pause state for itself in step 128. The external unit 50 monitors specified computer resources which includes a specified condition in step 132. The external unit detects the specified condition in step 136. The external unit initiates the active state of the thread in step 140 after detecting the specified condition in step 136.

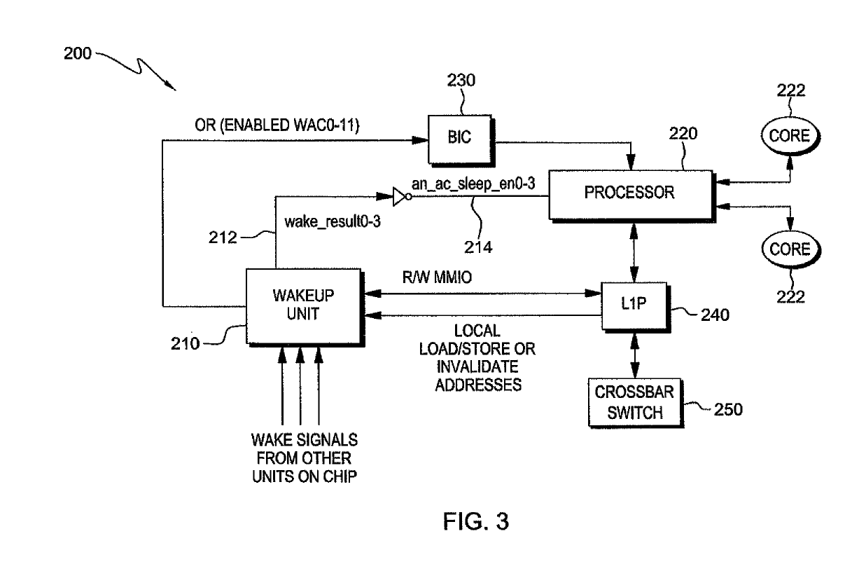

Referring to FIG. 3, a system 200 according to the present invention, depicts an external WakeUp unit 210 relationship to a processor 220 and to level-1 cache (L1p unit) 240. The processor 220 include multiple cores 222. Each of the cores 222 of the processor 220 has a WakeUp unit 210. The WakeUp unit 210 is configured and accessed using memory mapped I/O (MMIO), only from its own core. The system 200 further includes a bus interface card (BIC) 230, and a crossbar switch 250.

In one embodiment of the invention, the WakeUp unit 210 drives the signals wake_result0-3 212, which are negated to produce an_ac_sleep_en0-3 214. A processor 220 thread 40 (FIG. 1) wakes or activates on a rising edge of wake_result 212. Thus, throughout the WakeUp unit 210, a rising edge or value 1 indicates wake-up.

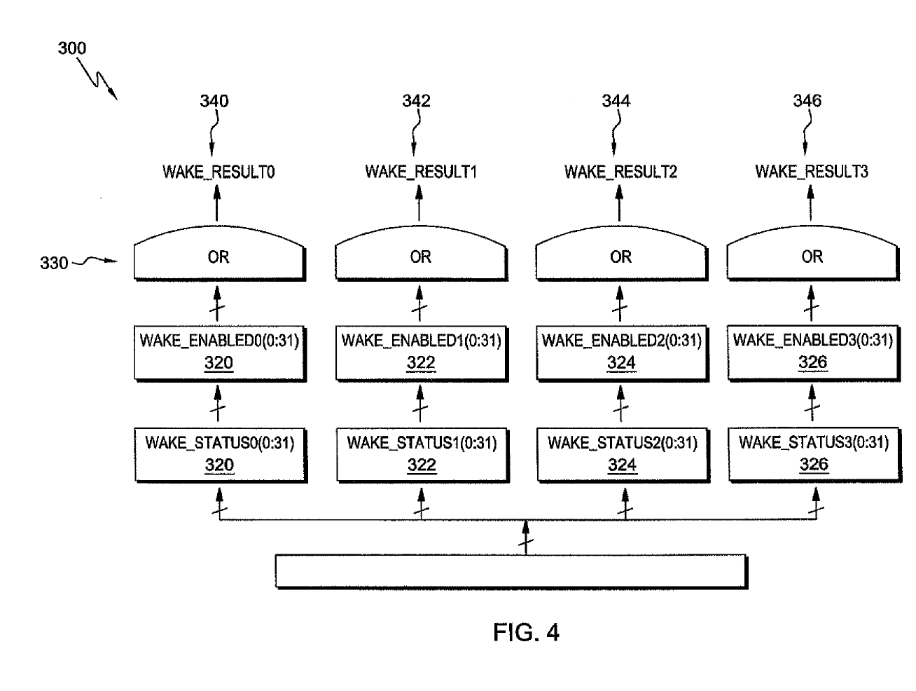

Referring to FIG. 4, a system 300 according to an embodiment of the invention includes the WakeUp unit 210 supporting 32 wake sources. These consist of 12 WakeUp address compare (WAC) units, 4 wake signals from the message unit (MU), 8 wake signals from the BIC's core-to-core (c2c) signaling, 4 wake signals are GEA outputs 12-15, and 4 so-called convenience bits. These 4 bits are for software convenience and have no incoming signal. The other 28 sources can wake one or more threads. Software determines which sources wake which threads. In FIG. 2, each of the 4 threads has its own wake_enableX(0:31) register and wake_statusX(0:31) register, where X=0, 1, 2, 3, 320-326, respectively. The wake_statusX(0:31) register latches each wake_source signal. For each thread X, each bit of wake_statusX(0:31) is ANDed with the corresponding bit of wake_enableX(0:31). The result is ORed together to create the wake_resultX signal for each thread.

The 1-bits written to the wake_statusX_clear MMIO address clears individual bits in wake_statusX. Similarly, the 1-bits written to the wake_statusX_set MMIO address sets individual bits in wake_statusX. A use of setting status bits is verification of the software. This setting/clearing of individual status bits avoids “lost” incoming wake_source transistions across sw-read-modify-writes.

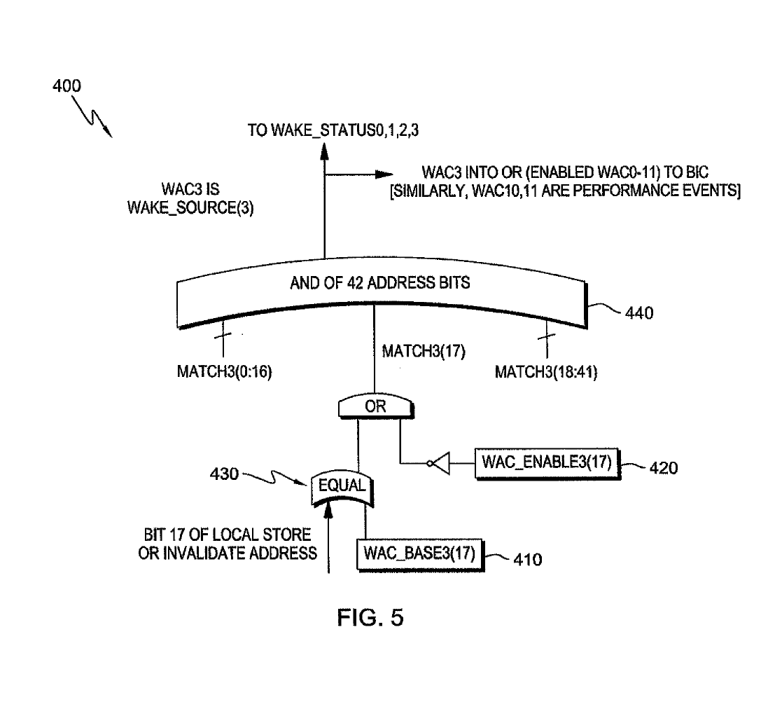

Referring to FIG. 5, in an embodiment of according to the invention, the WakeUp unit 210 includes 12 address compare (WAC) units, allowing WakeUp on any of 12 address ranges. In other words, 3 WAC units per processor hardware thread 40 (FIG. 1), though software is free to use the 12 WAC units differently across the 4 processor 220 threads 40. For example, 1 processor 220 thread 40 could use all 12 WAC units. Each WAC unit has its own 2 registers accessible via MMIO. The register wac_base is set by software to the address of interest. The register wac_enable is set by software to the address bits of interest and thus allows a block-strided range of addresses to be matched.

The DAC1 or DAC2 event occurs only if the data address matches the value in the DAC1 register, as masked by the value in the DAC2 register. That is, the DAC1 register specifies an address value, and the DAC2 register specifies an address bit mask which determines which bit of the data address should participate in the comparison to the DAC1 value. For every bit set to 1 in the DAC2 register, the corresponding data address bit must match the value of the same bit position in the DAC1 register. For every bit set to 0 in the DAC2 register, the corresponding address bit comparison does not affect the result of the DAC event determination.

Of the 12 WAC units, the hardware functionality for unit wac3 is illustrated in FIG. 5. The 12 units wac0 to wac11 feed wake_status(0) to wake_status(11). FIG. 5 depicts the hardware to match bit 17 of the address.

In an example, a level-2 cache (L2) record for each L2 line in 17 bits may be implemented for which the processor has performed a cached-read on the line. On a store to the line, the L2 then sends an invalidate to each subscribed core 222. The WakeUp unit snoops the stores by the local processor core and snoops the incoming invalidates.

The previous paragraph describes normal cached loads and stores. For the atomic L2 loads and stores, such as fetch-and-increment or store-add, the L2 sends invalidates for the corresponding normal address to the subscribed cores. The L2 also sends an invalidate to the core issuing the atomic operation, if that core was subscribed. In other words, if that core had a previous normal cached load on the address.

Thus each WakeUp WAC snoops all addressed stored to by the local processor. The unit also snoops all invalidate addresses given by the crossbar to the local processor. These invalidates and local stores are physical addresses. Thus software must translate the desired virtual address to a physical address to configure the WakeUp unit. The number of instructions taken for such address translation is typically much lower than the alternative of having the thread in a polling loop.

The WAC supports the full BGQ memory map. This allows a WAC to observe local processor loads or stores to MMIO. The local address snooped by WAC is exactly that output by the processor, which in turn is the physical address resolved by TLB within the processor. For example, WAC could implement a guard page on MMIO. In contrast to local processor stores, the incoming invalidates from L2 inherently only cover the 64 GB architected memory.

In an embodiment of the invention, the processor core allows a thread to put itself or another thread into a paused state. A thread in kernel mode puts itself into a paused state using a wait instruction or an equivalent instruction. A paused thread can be woken by a falling edge on an input signal into the processor 220 core 222. Each thread 0-3 has its own corresponding input signal. In order to ensure that a falling edge is not “lost”, a thread can only be put into a paused state if its input is high. A thread can only be paused by instruction execution on the core or presumably by low-level configuration ring access. The WakeUp unit wakes a thread. The processor 220 cores 222 wake up a paused thread to handle enabled interrupts. After interrupt handling completes, the thread will go back into a paused state, unless the subsequent paused state is overriden by the handler. Thus, interrupts are transparently handled. The WakeUp unit allows a thread to wake any other thread, which can be kernel configured such that a user thread can or cannot wake a kernel thread.

The WakeUp unit may drive the signals such that a thread of the processor 220 will wake on a rising edge. Thus, throughout the WakeUp unit, a rising edge or value 1 indicates wake-up. The WakeUp unit may support 32 wake sources. The wake sources may comprise 12 WakeUp address compare (WAC) units, 4 wake signals from the message unit (MU), 8 wake signals from the BIC's core-to-core (c2c) signaling, 4 wake signals are GEA outputs 12-15, and 4 so-called convenience bits. These 4 bits are for software convenience and have no incoming signal. The other 28 sources can wake one or more threads. Software determines which sources wake corresponding threads.

In one embodiment of the invention, a WakeUp unit includes 12 address compare (WAC) units, allowing WakeUp on any of 12 address ranges. Thus, 3 WAC units per A2 hardware thread, though software is free to use the 12 WAC units differently across the 4 A2 threads. For example, one A2 thread could use all 12 WAC units. Each WAC unit has its own two registers accessible via memory mapped I/O (MMIO). A register is set by software to a address of interest. The register is set by software to the address bits of interest and thus allows a block-strided range of addresses to be matched.

In another embodiment of the invention, data address compare (DAC) Debug Event Fields may include DAC1 or DAC2 event occurring only if the data address matches the value in the DAC1 register, as masked by the value in the DAC2 register. That is, the DAC1 register specifies an address value, and the DAC2 register specifies an address bit mask which determines which bit of the data address should participate in the comparison to the DAC1 value. For every bit set to 1 in the DAC2 register, the corresponding data address bit must match the value of the same bit position in the DAC1 register. For every bit set to 0 in the DAC2 register, the corresponding address bit comparison does not affect the result of the DAC event determination.

In another embodiment of the invention, an address compare on a wake signal, the WakeUp unit does not ensure that the thread wakes up after any and all corresponding memory has been invalidated in level-1 cache (L1). For example if a packet header includes a wake bit driving a wake source, the WakeUp unit does not ensure that the thread wakes up after the corresponding packet reception area has been invalidated in cache L1. In an example solution, the woken thread performs a data-cache-block-flush (dcbf) on the relevant addresses before reading them.

In another embodiment of the invention, a message unit (MU) provides 4 signals. The MU may be a direct memory access engine, such as MU 100, with each MU including a DMA engine and Network Card interface in communication with a cross-bar switch (XBAR) switch XBAR switch, and chip I/O functionality. MU resources are divided into 17 groups. Each group is divided into 4 subgroups. The 4 signals into WakeUp corresponds to one fixed group. An A2 core must observe the other 16 network groups via BIC. A signal is an OR command of specified conditions. Each condition can be individually enabled. An OR of all subgroups is fed into BIC, so a core serving a group other than its own must go via the BIC. The BIC provides core-to-core (c2c) signals across the 17*4-68 threads. The BIC provides 8 signals as 4 signal pairs. Any of the 68 threads can signal any other thread. Within each pair: 1 signal is OR of signals from threads on core 16. If source needed, software interrogates BIC to identify which thread on core 16. One signal is OR from threads on cores 0-15. If source needed, software interrogates BIC to identify which thread on which core.

In another embodiment of the invention, the WakeUp unit uses software, for example, using library routines. Handling multiple wake sources may be similarly managed as interrupt handling and requires avoiding problems like livelock. In addition to simplifying user software, the use of library routines also has other advantages. For example, the library can provide an implementation which does not use WakeUp unit and thus measures the application performance gained by WakeUp unit.

In one embodiment of the invention using interrupt handlers, assuming a user thread is paused waiting to be woken up by WakeUp, the thread enters an interrupt handler which uses WakeUp. A possible software implementation has the handler at exit set a convenience bit to subsequently wake the user to indicate that the WakeUp has been used by system and that user should poll all potential user events of interest. The software can be programmed to either have the handler or the user reconfigure the WakeUp for subsequent user use.

In another embodiment of the invention, a thread can wake another thread. One techniques for a thread to wake another thread is across A2 cores. Other techniques include core-to-core (c2c) interrupts, using a polled address. A write by the user thread to an address can wake a kernel thread. The address must be in user space. Across the 4 threads within an A2 core, have at least 4 alternative technique techniques. Since software can write bit=1 to wake_status, the WakeUp unit allows a thread to wake one or more other threads. For this purpose, any wake_status bit can be used whose wake_source can be turned off. Alternatively, setting wake_status bit=1 and toggle wake_enable. This allows any bit to be used, regardless if wake_source can be turned off. For the above techniques, if the wake status bit is kernel use only, a user thread cannot use the above method to wake the kernel thread.

Thereby, the present invention, provides a wait instruction (initiating the pause state of the thread) in the processor, together with the external unit that initiates the thread to be woken (active state) upon detection of the specified condition. Thus, preventing the thread from consuming resources needed by other threads in the processor until the pin is asserted. Thereby the present invention offloads the monitoring of computing resources, for example memory resources, from the processor to the external unit. Instead of having to poll a computing resource, a thread configures the external unit (or wakeup unit) with the information that it is waiting for, i.e., the occurrence of a specified condition, and initiates a pause state. The thread in pause state no longer consumes processor resources while it is in pause state. Subsequently, the external unit wakes the thread when the appropriate condition is detected. A variety of conditions can be monitored according to the present invention, including, writing to memory locations, the occurrence of interrupt conditions, reception of data from I/O devices, and expiration of timers.

In another embodiment of the invention, the system 10 and method 100 of the present invention may be used in a supercomputer system. The supercomputer system may be expandable to a specified amount of compute racks, each with predetermined compute nodes containing, for example, multiple processor cores. For example, each core may be associated to a quad-wide fused multiply-add SIMD floating point unit, producing 8 double precision operations per cycle, for a total of 128 floating point operations per cycle per compute chip. Cabled as a single system, the multiple racks can be partitioned into smaller systems by programming switch chips, which source and terminate the optical cables between midplanes.

Further, for example, each compute rack may consists of 2 sets of 512 compute nodes. Each set may be packaged around a doubled-sided backplane, or midplane, which supports a five-dimensional torus of size 4×4×4×4×2 which is the communication network for the compute nodes which are packaged on 16 node boards. The tori network can be extended in 4 dimensions through link chips on the node boards, which redrive the signals optically with an architecture limit of 64 to any torus dimension. The signaling rate may be 10 Gb/s, 8/10 encoded), over about 20 meter multi-mode optical cables at 850 nm. As an example, a 96-rack system is connected as a 16×16×16×12×2 torus, with the last x2 dimension contained wholly on the midplane. For reliability reasons, small torus dimensions of 8 or less may be run as a mesh rather than a torus with minor impact to the aggregate messaging rate. One embodiment of a supercomputer platform contains four kinds of nodes: compute nodes (CN), I/O nodes (ION), login nodes (LN), and service nodes (SN).

The method of the present invention is generally implemented by a computer executing a sequence of program instructions for carrying out the steps of the method and may be embodied in a computer program product comprising media storing the program instructions. Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations.

Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like, as well as a supercomputing environment. The invention may also be practiced in distributed computing environments where tasks are performed by remote processing devices that are linked through a communications network or other data transmission medium. In a distributed computing environment, program modules may be located in both local and remote computer storage media including memory storage devices.

An exemplary system for implementing the invention includes a computer with components of the computer which may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The computer may include a variety of computer readable media. Computer readable media can be any available media that can be accessed by computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer.

System memory may include computer storage media in the form of volatile and/or nonvolatile memory such as read only memory (ROM) and random access memory (RAM). A basic input/output system (BIOS), containing the basic routines that help to transfer information between elements within computer, such as during start-up, is typically stored in ROM. RAM typically contains data and/or program modules that are immediately accessible to and/or presently being operated on by processing unit. The computer may also include other removable/non-removable, volatile/nonvolatile computer storage media.

A computer may also operate in a networked environment using logical connections to one or more remote computers, such as a remote computer. The remote computer may be a personal computer, a server, a router, a network PC, a peer device or other common network node, and typically includes many or all of the elements described above relative to the computer. The present invention may apply to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

In another embodiment of the invention, to avoid race conditions, when using a WAC to reduce performance cost of polling, software use ensures two conditions are met such that no invalidates are missed for all the addresses of interest, the processor, and thus the WakeUp unit, is subscribed with the L2 slice to receive invalidates. The following pseudo-code meets the above conditions:

loop:
configure WAC
software read of all polled addresses

for each address whose value meets desired value, perform action.

if any address met desired value, goto loop:
wait instruction pauses thread until woken by WakeUp unit goto loop.

In alternative embodiments the present invention may be implemented in mutli-processor core SMP, like BGQ, wherein each core may be single or multi-threaded. Also, implementation may include a single thread node polling IO device, wherein the polling thread can consume resources, e.g., a crossbar, used by the IO device.

In alternative embodiments the present invention may be implemented in mutli-processor core SMP, like BGQ, wherein each core may be single or multi-threaded. Also, implementation may include a single thread node polling IO device, wherein the polling thread can consume resources, e.g., a crossbar, used by the IO device.

In an additional aspect according to the invention a pause unit may only know if desired memory location was written to. The pause unit may not know if a desired value was written. When a false resume is possible, software has to check condition itself. The pause unit may not miss a resume condition. For example, with the correct software discipline, the WakeUp unit guarantees that a thread will be woken up if the specified address(es) has been written to by any of the other 67 hw threads on the chip. Such writing includes the L2 atomic operations. In other words, the exit condition of a polling loop will never be missed. For a variety of reasons, a thread may be woken even if an the specified address(es) has not been written to. An example is false sharing of the same L1 cache line. Another example is an L2 castout due to resource pressure. Thus an awakened thread software must check if the exit condition of the polling loop has indeed been reached.

In an alternative embodiment of the invention, a pause unit can serve multiple threads. The multiple threads may or may not be within a single processor core. This allows address-compare units and other resume condition hardware to be shared by multiple threads. Further, the threads in the present invention may include barrier, and ticket locks threads.

Also, in an embodiment of the invention, a transaction coming from the processor may be restricted to particular types (memory operation types), for example, MESI shared memory protocol.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for enhancing performance of a computer, comprising:
providing a computer system including a data storage device, the computer system including a program stored in the data storage device and steps of the program being executed by a processor;
processing instructions from the program using the processor, the processor having a thread having an active state;
monitoring specified computer resources using an external unit being external to the processor;
configuring the external unit to detect a specified condition, the external unit being configured using the processor;
initiating a pause state for the thread after the step of configuring the external unit;
detecting the specified condition using the external unit; and
resuming the active state of the thread using the external unit when the specified condition is detected by the external unit.

2. The method of claim 1, wherein the resources are memory resources.

3. The method of claim 1, further comprising:
a plurality of conditions, including: writing to a memory location; receiving an interrupt command, receiving data from an I/O device, and expiration of a timer.

4. The method of claim 1, wherein the thread initiates the pause state itself.

5. The method of claim 1, further comprising:
configuring the external unit to detect the specified condition continuously over a period of time; and
polling the specified condition such that the thread and the external unit provide a polling loop of the specified condition.

6. The method of claim 5, further comprising:
defining an exit condition of the polling loop such that the external unit stops detecting the specified condition when the exit condition is met.

7. The method of claim 1, wherein the exit condition is a period of time.

8. A system for enhancing performance of a computer, comprising:
a computer system including a data storage device, the computer system including a program stored in the data storage device and steps of the program being executed by a processor, the processor processing instructions from the program;
an external unit being external to the processor for monitoring specified computer resources, and the external unit being configured to detect a specified condition using the processor;
a thread in the processor having an active state; and
a pause state for the thread being initiated by the thread, the thread resuming the active state using the external unit when the specified condition is detected by the external unit.

9. The system of claim 8, wherein the resources are memory resources.

10. The system of claim 8, further comprising:
a plurality of conditions, including: writing to a memory location; receiving an interrupt command, receiving data from an I/O device, and expiration of a timer.

11. The system of claim 8, further comprising:
a polling loop for polling the specified condition using the thread and the external unit to poll for the specified condition over a period of time.

12. The system of claim 11, further comprising:
an exit condition of the polling loop such that the external unit stops detecting the specified condition when the exit condition is met.

13. A computer program product comprising a computer readable medium having recorded thereon a computer program, a computer system including a processor for executing the steps of the computer program for enhancing performance of a computer, the program steps comprising:
processing instructions from the program using the processor;
monitoring specified computer resources using an external unit being external to the processor;
configuring the external unit to detect a specified condition;
providing a thread in the processor in an active state;
initiating a pause state for the thread after the step of configuring the external unit;
detecting the specified condition using the external unit; and
resuming the active state of the thread using the external unit when the specified condition is detected by the external unit.

14. The computer program product of claim 13 wherein the resources are memory resources.

15. The computer program product of claim 13, further comprising:
a plurality of conditions, including: writing to a memory location; receiving an interrupt command, receiving data from an I/O device, and expiration of a timer.

16. The computer program product of claim 13, wherein the thread initiates the pause state itself.

17. The computer program product of claim 13, further comprising:
configuring the external unit to detect the specified condition continuously over a period of time; and
polling the specified condition such that the thread and the external unit provide a polling loop of the specified condition.

18. The computer program product of claim 13, further comprising:
defining an exit condition of the polling loop such that the external unit stops detecting the specified condition when the exit condition is met.

19. The computer program product of claim 13, wherein the exit condition is a period of time.
